(19) United States
(12) Patent Application Publication
(10) Pub. No.: US 2019/0081374 A1
(43) Pub. Date: Mar. 14, 2019

(54) TRACTION BATTERY WITH BATTERY TEMPERATURE CONTROL SYSTEM

(71) Applicant: Mahle International GmbH, Stuttgart (DE)

(72) Inventors: Dragos-Cristian Iancu, Hitzhofen (RO); Michael Kranich, Gemmrigheim (DE); Michael Moser, Ellwangen (DE); Walter Wolf, Oppenweiler-Zell (DE)

(21) Appl. No.: 16/126,807

(22) Filed: Sep. 10, 2018

(30) Foreign Application Priority Data
Sep. 11, 2017 (DE) 10 2017 215 987.1

(51) Int. Cl. H01M 10/6556; H01M 10/613; H01M 10/615; H01M 10/625; H01M 10/63; F28F 9/02; B60L 11/18

(52) U.S. Cl. CPC H01M 10/6556; H01M 10/613; H01M 10/615; H01M 10/625; B60L 11/1879; F28F 9/0256; B60L 11/1874; B60L 11/1875; H01M 10/63

(57) ABSTRACT

A battery temperature control system for controlling a temperature of a traction battery of a vehicle may include a first heat exchanger including a first inlet for a temperature control medium and a first outlet for the temperature control medium. The system may also include a second heat exchanger arranged distally to the first heat exchanger including a second inlet and a second outlet. The system may further include a supply channel connecting a supply connection to the first inlet and to the second inlet, and a discharge channel connecting a discharge connection to the first outlet and to the second outlet. The supply channel and the discharge channel may be formed in a shared multi-channel tube, to which the first inlet, the second inlet, the first outlet, and the second outlet are connected. The multi-channel tube may include the supply connection and the discharge connection.

### CROSS-REFERENCE TO RELATED APPLICATIONS

This application claims priority to German Patent Application No. DE 10 2017 215 987.1, filed on Sep. 11, 2017, the contents of which are hereby incorporated by reference in its entirety.

### TECHNICAL FIELD

The present invention relates to a battery temperature control system for controlling the temperature of a traction battery of a vehicle. The invention relates furthermore to a traction battery of a vehicle which is equipped with such a battery temperature control system.

In the present context, the term “controlling the temperature” is understood to mean the setting of a desired temperature, irrespective of whether, to do this, heat must be conveyed away or introduced. Temperature control therefore comprises both a cooling and also a heating.

### BACKGROUND

A traction battery of a vehicle provides the electrical energy which an electric drive of a vehicle requires in order to generate the propulsion of the vehicle. The traction battery can also provide the electrical energy necessary in the on-board power system of the vehicle for other electrical consumers. With power output, the battery heats up and must be cooled to prevent damage and for optimum power output. At low ambient temperatures, on the other hand, a heating of the battery is necessary, in order to prevent damage to the battery or respectively to guarantee an optimum power output. For this purpose, a traction battery can be equipped with a battery temperature control system.

Such a battery temperature control system can be coupled in a heat-transmitting manner to the respective traction battery in a variety of ways. Likewise, quasi any number of complex possibilities exist for the integration of such a battery temperature control system into such a traction battery. The more complex the degree of integration, the more laborious is the formation of variants for the case where the battery temperature control system has to be adapted to traction batteries of different size.

### SUMMARY

The present invention is concerned with the problem of indicating, for a battery temperature control system or respectively for a traction battery equipped therewith, an improved embodiment which is distinguished in particular by a simple construction or respectively by an economically priced construction. Furthermore, a simple adaptation of the battery temperature control system to different dimensions of a traction battery is to be possible.

This problem is solved according to the invention by the subject of the independent claim(s). Advantageous embodiments are the subject of the dependent claim(s).

The invention is based on the general idea of equipping the battery temperature control system with a multi-channel tube, in which a supply channel for a temperature control medium and a discharge channel for the temperature control medium are formed adjacent to one another. By means of this multi-channel tube, two separate heat exchangers, namely a first heat exchanger and a second heat exchanger can be fluidically connected to a supply connection, via which the temperature control medium is supplied to the battery temperature control system, and to a discharge connection, via which the temperature control medium is discharged from the battery temperature control system. The two heat exchangers can be arranged on the respective traction battery or respectively on a sub-module of the traction battery at locations remote from one another, in order to bring about the respective temperature control at different locations. Via the shared multi-channel tube, the two heat exchangers are connected in parallel, which significantly simplifies the fluidic integration of the two heat exchangers into the battery temperature control system with regard to the wiring. In particular, the wiring for integrating the battery temperature control system into a temperature control circuit, in which the temperature control medium circulates, is thereby simplified. Such a temperature control circuit can have a temperature control medium pump for driving the temperature control medium, a heat sink for cooling the temperature control medium, and a heat source for heating the temperature control medium. Furthermore, via the dimensioning of the multi-channel tube, it is particularly simple to adapt this battery temperature control system to different dimensions of the traction battery, without for example the heat exchangers having to be differently dimensioned for this. By means of the length of the multi-channel tube, for example the spacing of the two heat exchangers can be set or respectively determined and therefore can be adapted in a simple manner to different dimension, arrangements and connections of cells.

Usually, a traction battery consists of a plurality of sub-modules or cell modules for better handling. Such a module is formed here by the connecting of individual cells in a single-row or multiple-row cell stack to achieve a manageable unit with a desired voltage level and storage capacity. Currently, sub-modules are usual which lie below 60V direct current voltage, in order to thereby be able to keep the prescribed security expenditure in manufacture and assembly lower. The cell modules are connected later, if required, to a battery with higher voltage and/or storage capacity. A parallel connection increases the storage capacity and a series connection raises the voltage level of the cell assembly or of the battery overall. A traction battery consists of at least one cell module.

In detail, the first heat exchanger for temperature control of the traction battery has a first inlet for temperature control medium and a first outlet for temperature control medium. The second heat exchanger, arranged distally, therefore remote or respectively at a distance from the first heat exchanger, has a second inlet for temperature control medium and a second outlet for temperature control medium, for temperature control of the traction battery.

For an efficient heat transport, in such a battery temperature control system usually a liquid temperature control medium is used, which is preferably a water-based liquid. Depending on the function of the battery temperature control system, the temperature control medium is accordingly a heating medium or respectively a cooling medium. Refrigerants can also come into use, which can then receive energy through a phase change.

Within the battery temperature control system, a supply channel connects said supply connection in a parallel manner with the first inlet and with the second inlet, while a discharge channel connects said discharge connection in a parallel manner with the first outlet and with the second outlet. In the battery temperature control system according to the invention, the supply channel and the discharge channel are now formed in the shared multi-channel tube. The multi-channel tube is connected here to the first inlet, the second inlet, the first outlet and the second outlet and has, in addition, the supply connection and the discharge connection.

According to an advantageous embodiment, the multi-channel tube can have tube body which surrounds an interior space in circumferential direction. The circumferential direction of the tube body runs around a longitudinal centre axis of the tube body or respectively of the multi-channel tube. In the tube body a dividing wall is formed which extends in the longitudinal direction of the tube body or respectively of the multi-channel tube and which separates, in the interior space, the supply channel from the discharge channel. Hereby, the supply channel and the discharge channel are arranged parallel to one another and adjacent to one another in the tube body, so that the supply channel and the discharge channel extend respectively in the longitudinal direction of the tube body. Hereby, the multi-channel tube has a particularly simple structure. The multi-channel tube is preferably configured so as to be rectilinear. On other embodiments, however, it is conceivable to configure the multi-channel tube so as to be curved or to provide it with at least one bend portion which connects two straight or curved portions with one another.

Another embodiment makes provision that the multi-channel tube has at least one tube section which is formed by a multi-chamber profile. Such a multi-chamber profile can be produced particularly simply at an economical price for example by extrusion or by extrusion moulding. The multi-chamber profile has at least two chambers separated from one another by a web, one chamber of which forms the supply channel in the multi-channel tube, while the other chamber forms the discharge channel. In so far as the above-mentioned tube body is formed by means of the multi-chamber profile, the web of the multi-chamber profile forms the dividing wall in the tube body.

Another embodiment proposes that the multi-chamber tube has at least two tube sections which are inserted into one another in the longitudinal direction of the multi-chamber tube. A first of these tube sections is then connected to the first inlet and to the first outlet, while a second of these tube sections is connected to the second inlet and to the second outlet. In so far as only two tube sections are present, the first tube section is connected to the first heat exchanger, while the second tube section is connected to the second heat exchanger. If more than two tube sections are present, at least one further tube section is arranged between the first tube section and the second tube section, wherein plug-in connections are also provided here. These tube sections can also be configured respectively as multi-chamber profiles and/or can respectively form a tube body with dividing wall.

According to another embodiment, the first inlet and the first outlet can be arranged at a first longitudinal end of the multi-channel tube, preferably axially. The second inlet and the second outlet can then be arranged at a second longitudinal end of the multi-channel tube remote from the first longitudinal end, preferably axially. In contrast thereto, the supply connection and the discharge connection can adjoin radially onto the multi-channel tube. Expediently, the supply connection is arranged at the first longitudinal end of the multi-channel tube, while the discharge connection is arranged at the second longitudinal end of the multi-channel tube.

Expediently, the respective heat exchanger can have a distributor box fluidically connected to the associated inlet, a collector box fluidically connected to the associated outlet, and a plurality of connecting tubes which connect the distributor box to the collector box. The heat transmission between the temperature control medium and the traction battery takes place substantially via these connecting tubes. In the cooling operation of the battery temperature control system, these connecting tubes serve for heat absorption, so that the connecting tubes act as cooling tubes and the associated heat exchanger acts as a cooler. In contrast thereto, in the heating operation of the battery temperature control system, these connecting tubes serve for heat emission, so that the connecting tubes act as heating tubes and the associated heat exchanger acts as a heater. Expediently here the first heat exchanger and the second heat exchanger can be configured so as to be substantially identical in construction, in order to increase the number of units by way of identical parts and to reduce the production costs. An embodiment is preferred in which the first heat exchanger and the second heat exchanger are configured mirror-symmetrically. In the assembled state, when the battery temperature control system is mounted on the traction battery, the mirror symmetry can refer to a longitudinal centre plane which extends perpendicularly to the longitudinal direction of the multi-channel tube. The two heat exchangers then extend substantially parallel to one another. The mirror-symmetrical second heat exchanger can be produced here substantially from the identical individual parts.

A particular embodiment proposes that the supply connection adjoins onto the multi-channel tube radially, penetrates the discharge channel internally in the multi-channel tube and opens out in the supply channel, so that the supply connection is flowed around by or respectively is able to be flowed around by the temperature control medium in the discharge channel. In contrast thereto, the discharge connection adjoins radially onto the multi-channel tube and opens out internally in the multi-channel tube directly in the discharge channel. Hereby, it is possible to connect the discharge connection and supply connection on the same side radially onto the multi-channel tube, such that the supply channel faces away from this connection side, whereas the discharge channel faces this connection side. It is clear that basically also a reverse structural form is conceivable, in which the supply channel is arranged between the discharge channel and the connection side, so that in this case the discharge connection is directed through the supply channel. Likewise, it is conceivable to connect the supply connection and the discharge connection on opposite sides onto the multi-channel tube, so that the supply connection opens directly into the supply channel, whereas the discharge connection opens directly into the discharge channel.

It is particularly advantageous here if the battery temperature control system is configured for adding on to a battery cell block of the traction battery. Such a constructed or added-on system therefore differs from an integrated system. The constructed system can be adapted more easily to varying battery cell blocks, e.g. by adapting the length of the multi-channel tube.

A traction battery for a vehicle, according to the invention, comprises a plurality of flat battery cells which are arranged adjacent to one another such that they form a parallelepiped-shaped battery cell block. Furthermore, the traction battery is equipped with a battery temperature control system of the type described above. For this, the first heat exchanger is arranged at a first longitudinal end of the battery cell block and is coupled there with the battery cells in a heat-transmitting manner. The second heat exchanger, on the other hand, is arranged at a second longitudinal end of the battery cell block remote from the first longitudinal end and is coupled there with the battery cells in a heat-transmitting manner. The multi-channel tube is then arranged on a longitudinal side of the battery cell block. The longitudinal direction of the battery cell block is defined here by the longitudinal direction of the elongated and flat battery cells, so that the longitudinal ends of the battery cells are situated at the longitudinal ends of the battery cell block. Usually, the individual battery cells are equipped at their longitudinal ends with electrical connections. At the longitudinal ends of the battery cell block an electrical connection of the individual battery cells then takes place by means of corresponding connectors, wherein here both series connections and also parallel connections come into consideration. These connectors can be configured as flat metal plates which are situated at the respective longitudinal end of the battery cell block. Particularly advantageously, the respective heat exchanger is coupled with these connectors or respectively with these metal plate in a heat-transmitting manner. For example, the respective heat exchanger can be arranged at the respective longitudinal end of the battery cell block so that the connecting tubes of the respective heat exchanger are situated between the connectors and the battery cells, so that the electrical contacting of the connectors with the electrical connections at the longitudinal ends of the battery cells takes place quasi through intermediate spaces of adjacent connecting tubes.

Expediently here the battery temperature control system is added on to the battery cell block. Hereby, the battery temperature control system can be adapted more easily to varying battery cell blocks. For this purpose, in particular provision can be made that the multi-channel tube is a separate component with respect to the battery cell block. Additionally or alternatively, provision can be made that the first heat exchanger and/or the second heat exchanger are separate components with respect to the battery cell block.

Further important features and advantages of the invention will emerge from the subclaims, the drawings and the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown, respectively diagrammatically,

FIG. 1 an isometric view of a traction battery with a battery temperature control system,

FIG. 2 an isometric view of a first heat exchanger of the battery temperature control system,

FIG. 3 a longitudinal section of the battery temperature control system in the region of the multi-channel tube,

FIG. 4 a cross-section of the multi-channel tube according to section liens IV in FIG. 3, and

FIG. 5 a cross-section of the multi-channel tube in the region of a supply connection according to section lines V in FIG. 3.

### DETAILED DESCRIPTION

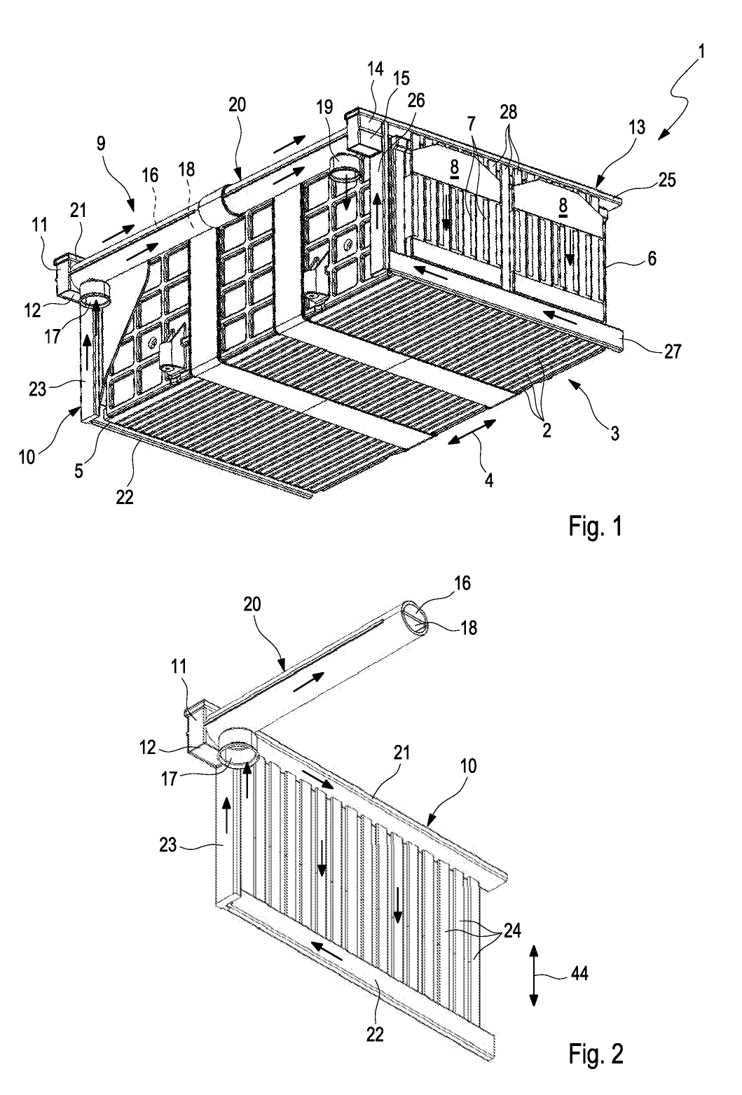

According to FIG. 1, a traction battery 1 of a motor vehicle comprises a plurality of battery cells 2. The individual battery cells 2 are elongated, flat and substantially even bodies, which are arranged adjacent to one another so that they form a parallelepiped-shaped battery cell block 3. This battery cell block 3 represents at the same time a cell module of the traction battery 1. In the example which is shown here, the traction battery 1 has only one such cell module. In other embodiments, the traction battery 1 can also have two or more cell modules.

A longitudinal direction 4 of the battery cell block 3, indicated by a double arrow in FIG. 1, is defined here through the longitudinal directions of the battery cells 2 running parallel to one another, so that all the battery cells 2 at one end terminate at a first longitudinal end 5 of the battery cell block 3 which faces away from the observer in FIG. 1, and at the other end terminate at a second longitudinal end 6 of the battery cell block 3, which faces the observer in FIG. 1. At their longitudinal ends, the battery cells 2 are equipped with electrical connections 7 and are connected to one another suitably in a serial or respectively parallel manner. At the respective longitudinal end 5, 6 of the battery cell block 3, corresponding connectors 8 are arranged for this, which are embodied here as flat metal plates. The individual battery cells 2 can be, in particular, so-called pouch cells. Basically, however, other types of battery cells are also conceivable.

The traction battery 1 is equipped, in addition, with a battery temperature control system 9, which serves for the temperature control, therefore depending on requirements for cooling and for heating the traction battery 1 or respectively the cell module or respectively the battery cell block 3. In so far as the traction battery 1 has a plurality of cell modules or respectively a plurality of battery cell blocks 3, it can basically have one such battery temperature control system 9 for each cell module or respectively for each battery cell block 3. The battery temperature control system 9 is added on to the battery cell block 3 here in accordance with FIG. 1, and is therefore configured separately in this respect.

This battery temperature control system 9 has a first heat exchanger 10 for the temperature control of the traction battery 1, which has a first inlet 11 for temperature control medium and a first outlet 12 for temperature control medium. This first heat exchanger 10 is arranged at the first longitudinal end 5 of the battery cell block 3 and is coupled there with the battery cells 2 in a heat-transmitting manner. The battery temperature control system 9 has in addition a second heat exchanger 13, which is arranged distally, therefore remote from the first heat exchanger 10, and likewise serves for the temperature control of the traction battery 1. The second heat exchanger 13 has a second inlet 14 for temperature control medium and a second outlet 15 for temperature control medium. The second heat exchanger 13 is arranged at the second longitudinal end 6 of the battery cell block 3 and is coupled there with the battery cells 2 in a heat-transmitting manner. Expediently, the respective heat exchanger 10, 13 is arranged at the respective longitudinal end 5, 6 of the battery cell block 3 so that the heat-transmitting coupling with the battery cells 2 takes place in the region of the connectors 8. The first heat exchanger 10 and the second heat exchanger 13 are separate components with respect to the battery cell block 3.

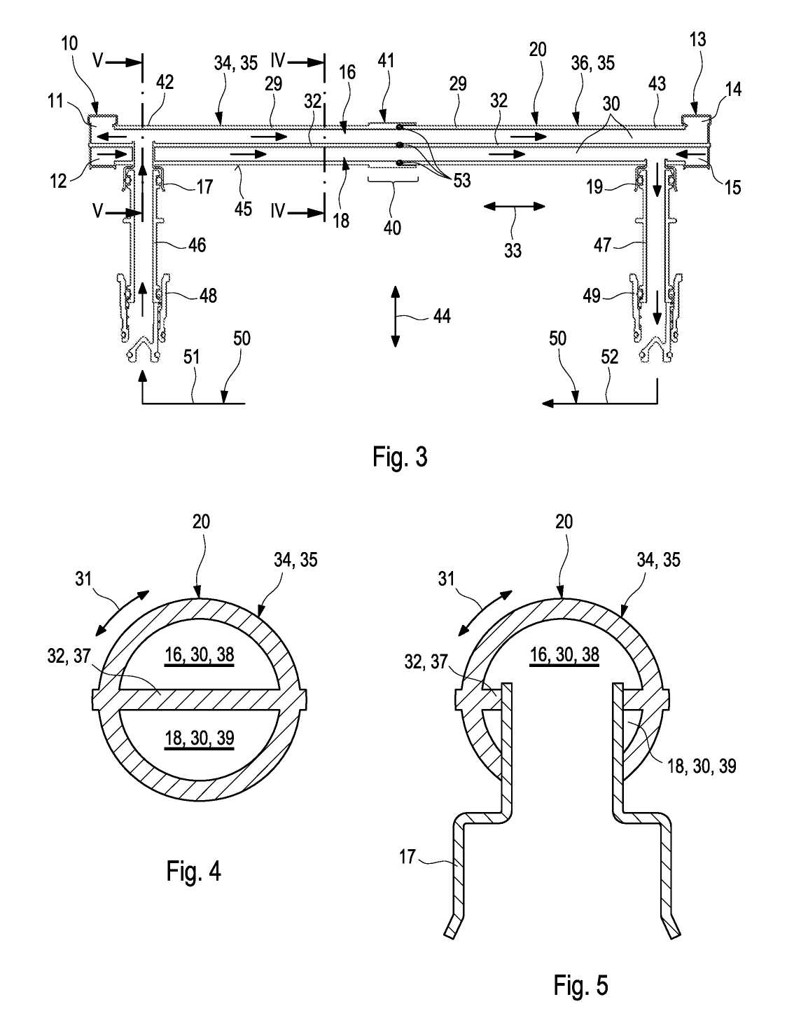

According to FIGS. 1 to 5, the battery temperature control system 9 has a supply channel 16 which connects, in a parallel manner and fluidically, a supply connection 17, via which the temperature control medium is supplied to the battery temperature control system 9 from a feed 51 of a temperature control circuit 50, only indicated in FIG. 3, with the first inlet 11 and with the second inlet 14. In addition, the battery temperature control system 9 has a discharge channel 18 which connects, in a parallel manner and fluidically, a discharge connection 19, via which the temperature control medium is discharged from the battery temperature control system 9 and is supplied to a return 52 of the temperature control circuit 50, only indicated in FIG. 3, with the first outlet 12 and with the second outlet 15. The battery temperature control system 9 is equipped in addition with a shared multi-channel tube 20, in which the supply channel 16 and the discharge channel 18 are formed. The first inlet 11, the second inlet 14, the first outlet 12 and the second outlet 15 are connected to this multi-channel tube 20. In addition, the supply connection 17 and the discharge connection 19 are connected to the multi-channel tube 20 or respectively are formed thereon. According to FIG. 1, in the assembled state the multi-channel tube 20 is arranged on a longitudinal side of the battery cell block 3 which faces the observer. The multi-channel tube 20 is a separate component with respect to the battery cell block 3.

According to FIG. 2, the first heat exchanger 10 has a first distributor box 21 which is fluidically connected to the first inlet 11. In addition, the first heat exchanger 10 has a first collector box 22, which is fluidically connected to the first outlet 12 via a first return tube 23. Finally, the first heat exchanger 10 has a plurality of first connecting tubes 24, which fluidically connect the first distributor box 21 to the second distributor box 22. These first connecting tubes 24 extend along the first longitudinal end 5 of the battery cell block 3, preferably between the above-mentioned connectors 8 and the longitudinal ends of the individual battery cells 2, so that the electrical connections 7 extend through intermediate spaces between adjacent first connecting tubes 24. Expediently, the second heat exchanger 13 according to FIG. 1 is configured so as to be identical in construction or respectively mirror-symmetrical to the first heat exchanger 10. Accordingly, the second heat exchanger 13 has a second distributor box 25 fluidically connected to the second inlet 14, a second collector box 27 fluidically connected to the second outlet 15 via a second return tube 26, and a plurality of second connecting tubes 28, which fludically connect the second distributor box 25 to the second collector box 27.

According to FIGS. 3 to 5, the multi-channel tube 20 has a tube body 29, which surrounds an interior space 30 in a circumferential direction 31 indicated by a double arrow in FIGS. 4 and 5. This circumferential direction 31 refers here to the multi-channel tube 20. In the tube body 29 a dividing wall 32 is formed, which extends in the longitudinal direction 33 of the tube body 29, which is indicated by a double arrow in FIG. 3, and which separates the supply channel 16 from the discharge channel 18 in the interior space 30. The supply channel 16 and discharge channel 18 extend respectively in the longitudinal direction 33 of the tube body 29 and therefore of the multi-channel tube 20 and are arranged here in the tube body 29 parallel to one another or respectively adjacent to one another, therefore side by side. In the example, the multi-channel tube 20 is designed so as to be rectilinear. A curved or bent shape or a configuration with curved and straight portions is likewise conceivable. The supply channel 16, the discharge channel 18 and the possibly present dividing wall 32 then follow this shape or respectively configuration. The multi-channel tube 20, instead of being configured as an extrusion- or extrusion moulded- profile, can also be configured as a rolled or folded profile or can be produced having multiple parts (e.g. as stamped, bent or other formed parts) or as a cast part, in particular a precision cast part or injection moulded part. With a production having multiple parts, the parts can be connected to one another by welding, soldering or bonding methods. In addition to metals, the heat exchangers and their components can also be produced entirely or partly from plastic materials.

Furthermore, the multi-channel tube 20 comprises at least one tube section 34 which is formed from a tube section 34 which is formed from a multi-chamber profile 35. In the example shown here, two tube sections 34 and 36 are provided, which are respectively formed by a multi-chamber profile 35. The multi-chamber profile 35 has at least two chambers 38 and 39, separated from one another by a web 37. The one or first chamber 38 forms the supply channel 16, while the other or second chamber 39 forms the discharge channel 18. In the tube body 29, the web 37 of the multi-chamber profile 35 forms the dividing wall 32.

In so far as, as here, two tube sections 34, 36 are provided in order to form the multi-chamber tube 20, these can be inserted into one another expediently in an insertion region 40 in the longitudinal direction 33 of the tube body 29 or respectively of the multi-chamber tube 20. A corresponding plug-in connection is designated here by 41. The left or first tube section 34, illustrated on the left in FIG. 3, is connected to the first inlet 11 and to the first outlet 12. In contrast thereto, the right or second tube section 36, illustrated on the right in FIG. 3, is connected to the second inlet 14 and to the second outlet 15. In the insertion region 40 or respectively in the plug-in connection 41, the first tube section 34 and the second tube section 36 are inserted into one another in a fluidically sealed manner, such that the portion of the supply channel 16 formed in the first tube section 34 is fluidically connected to the portion of the supply channel 16 formed in the second tube section 36, while the portion of the discharge channel 18 formed in the first tube section 34 is fluidically connected to the portion of the discharge channel 18 formed in the second tube section 36. In so far as more than two tube sections 34, 36 are provided for the formation of the multi-channel tube 20, each further tube section is arranged axially between the first tube section 34 and the second tube section 36, wherein corresponding plug-in connections 41 come into use. In addition, a seal 53 can also come into use in the insertion region 40, in order to seal the tube sections 34, 36 or respectively the chambers 38, 39 or respectively the channels 16, 18 axially and/or radially.

In the example of the battery temperature control system 9 illustrated here, the first inlet 11 and the first outlet 12 are arranged axially at a first longitudinal end 42 of the multi-channel tube 20. At this first longitudinal end 42, in addition the supply connection 17 is arranged radially here. At a second longitudinal end 43 of the multi-channel tube 20, which is remote from the first longitudinal end 42, the second inlet 14 and the second outlet 15 are arranged axially, wherein here, in addition, the discharge connection 19 is arranged radially at the second longitudinal end 43. The respective axial direction and radial direction refers here to the longitudinal direction 33 of the multi-channel tube 20.

In the preferred example embodiment shown here, the supply channel 16 and the discharge channel 18 are arranged adjacent to one another or respectively one over the other in a connection direction 44 indicated by a double arrow in FIGS. 2 and 3. This connection direction 44 extends here expediently parallel to the longitudinal directions of the first connecting tubes 24. Expediently, the two heat exchangers 10, 13 are arranged so as to be mirror-symmetrical, so that the connection direction 44 also extends parallel to the longitudinal directions of the second connecting tubes 28. In any case, the multi-channel tube 20 has a connection side 45, at which both the supply connection 17 and also the discharge connection 19 are arranged aligned radially and parallel to the connection direction 44. In the example which is shown, the discharge channel 18 is arranged with respect to the connection direction 44 between this connection side 45 and the supply channel 16. Accordingly, the supply connection 17 adjoins radially onto the multi-chamber tube 20 and penetrates the discharge channel 18 internally in the multi-chamber tube 20 and opens out in the supply channel 18. In the discharge channel 18, the supply connection 17 is able to be flowed around by the temperature control medium. Accordingly, the supply connection 17 in the discharge channel 18 blocks only a portion of the cross-section of the discharge channel 18 which is able to be flowed through. This can be seen particularly clearly in FIG. 5. In contrast thereto, the discharge connection 19 is connected to the multi-chamber tube 20 radially, so that it opens out directly therein in the discharge channel 18. The blocking of the discharge channel 18 by the supply connection 17, illustrated by way of example in FIG. 5, can of course be reduced, e.g. by the cross-sections and volume flows showing different conditions. In particular, in the region of the connections 17, 19 a local cross-section widening of at least one channel 16, 18 can be provided.

In FIG. 3 in addition a supply tube section 46 and a discharge tube section 47 can be seen. The supply tube section 46 connects the supply connection 17 to a feed connection 48, which is formed at the feed 51 of the temperature control circuit 50, to which the battery temperature control system 9 is connected. The discharge tube section 47 connects the discharge connection 19 to a return connection 49, which is formed at the return 51 of the temperature control circuit 50. The feed connection 48 and return connection 49 can be arranged here in a housing to receive the battery cell block 3.

1. A battery temperature control system for controlling a temperature of a traction battery of a vehicle, comprising:
a first heat exchanger for a temperature control of the traction battery, which includes a first inlet for a temperature control medium and a first outlet for the temperature control medium;
a second heat exchanger arranged distally to the first heat exchanger, for the temperature control of the traction battery, which includes a second inlet for the temperature control medium and a second outlet for the temperature control medium;
a supply channel connecting a supplyu connection, in a parallel manner, to the first inlet and to the second inlet, and
a discharge channel connecting a discharge connection, in a parallel manner, to the first outlet and to the second outlet;
wherein the supply channel and the discharge channel are formed in a shared multi-channel tube, to which the first inlet, the second inlet, the first outlet, and the second outlet are connected, and which includes the supply connection and the discharge connection.

2. The battery temperature control system according to claim 1, wherein:
the multi-channel tube includes a tube body surrounding an interior space in a circumferential direction; and
that in the tube body a divding wall is arranged, which extends in a longitudinal direction of the tube body and which, in the interior space, separates the supply channel from the discharge channel such that the supply channel and the discharge channel extend parallel to one another and adjacent to one another in the tube body.

3. The battery temperature control system according to claim 1, wherein the multi-channel tube has at least one tube section of a multi-chamber profile, which includes at least two chambers separated from one another via a web, one chamber of the at least two chambers defining the supply channel and the other chamber defining the discharge channel.

4. The battery temperature control system according to claim 1, wherein the multi-channel tube includes at least two tube sections inserted into one another in a longitudinal direction of the multi-channel tube such that one tube section of the at least two tube sections is connected to the first inlet and to the first outlet, and the other tube section is connected to the second inlet and to the second outlet.

5. The battery temperature control system according to claim 1, wherein:
the first inlet and the first outlet are arranged at a first longitudinal end of the multi-channel tube; and
the second inlet and the second outlet are arranged at a second longitudinal end of the multi-channel tube remote from the first longitudinal end.

6. The battery temperature control system according to claim 5, wherein:
the supply connection is arranged at the first longitudinal end of the multi-channel tube; and
the discharge connection is arranged at the second longitudinal end of the multi-channel tube.

7. The battery temperature control system according to claim 6, wherein:
the first inlet, the first outlet, the second inlet, and the second outlet are arranged axially at a respective longitudinal end of the multi-channel tube; and
the supply connection and the discharge connection are arranged radially at the respective longitudinal end of the multi-channel tube.

8. The battery temperature control system according to claim 1, wherein at least one of:
the first heat exchanger includes a first distributor box fluidically connected to the first inlet, a first collector box fluidically connected to the first outlet, and a plurality of first connecting tubes fluidically connecting the first distributor box to the first collector box; and
the second heat exchanger includes a second distributor box fluidically connected to the second inlet, a second collector box fluidically connected to the second outlet, and a plurality of second connecting tubes fluidically connecting the second distributor box to the second collector box.

9. The battery temperature control system according to claim 1, wherein one of:
the supply connection adjoins radially onto the multi-channel tube, penetrates the discharge channel internally in the multi-channel tube and opens out in the supply channel, wherein the temperature control medium is flowable around the supply connection in the discharge channel, and the discharge connection adjoins radially onto the multi-channel tube and opens directly in the discharge channel internally in the multi-channel tube; and
the discharge connection adjoins radially onto the multi-channel tube, penetrates the supply channel internally in the multi-channel tube and opens out in the discharge channel, wherein the temperature control medium is flowable around the discharge connection in the supply channel, and the supply connection adjoins radially onto the multi-channel tube and opens out directly in the supply channel internally in the multi-channel tube.

10. A traction battery for a vehicle, comprising:
a plurality of flat battery cells arranged adjacent to one another and form a parallelepiped-shaped battery cell block;
a battery temperature control system including:
a first heat exchanger including a first inlet for a temperature control medium and a first outlet for the temperature control medium;
a second heat exchanger arranged distaly to the first heat exchanger including a second inlet for the temperature control medium and a second outlet for the temperature control medium;
a multi-channel tube including a supply connection and a discharge connection, the multi-channel tube connected to the first inlet, the second inlet, the first outlet, and the second outlet
a supply channel disposed within the multi-channel tube connecting the supply connection to the first inlet and the second inlet in a parallel manner; and
a discharge channel disposed within the multi-channel tube connecting the discharge connection to the first outlet and the second outlet in a parallel manner;
the first heat exchanger arranged at a first longitudinal end of the battery cell block and coupled thereto in a heat-transmitting manner;
the second heat exchanger arranged at a second longitudinal end of the battery cell block, remote from the first longitudinal end, and coupled thereto in a heat-transmitting manner; and
the multi-channel tube arranged at a longitudinal side of the battery cell block.

11. The traction battery according to claim 10, wherein the battery temperature control system is a separate component from the battery cell block and is coupled thereto.

12. The traction battery according to claim 10, wherein the multi-channel tube is a separate component from the battery cell block.

13. The traction battery according to claim 10, wherein the at least one of the first heat exchanger and the second heat exchanger is a separate component from the battery cell block.

14. The battery temperature control system according to claim 1, wherein the battery temperature control system is configured to be coupled on to a battery cell block of the traction battery.

15. The battery temperature control system according to claim 2, wherein the multi-channel tube has a multi-chamber profile defining at least one tube section, the multi-chamber profile including at least two chambers separated from one another via a web, one chamber of the at least two chambers defining the supply channel and the other chamber defining the discharge channel.

16. The battery temperature control system according to claim 2, wherein:
the first inlet and the first outlet are arranged axially at a first longitudinal end of the multi-channel tube; and
the second inlet and the second outlet are arranged axially at a second longitudinal end of the multi-channel tube opposite the first longitudinal end.

17. The battery temperature control system according to claim 16, wherein:
the supply connection is arranged radially at the first longitudinal end of the multi-channel tube; and
the discharge connection is arranged radially at the second longitudinal end of the multi-channel tube.

18. The battery temperature control system according to claim 2, wherein at least one of:
the first heat exchanger includes a first distributor box fluidically connected to the first inlet, a first collector box fluidically connected to the first outlet, and a plurality of first connecting tubes fluidically connecting the first distributor box to the first collector box; and
the second heat exchanger includes a second distributor box fluidically connected to the second inlet, a second collector box fluidically connected to the second outlet, and a plurality of second connecting tubes fluidically connecting the second distributor box to the second collector box.

19. A battery temperature control system for controlling a temperature of a traction battery of a vehicle, comprising:
a first heat exchanger including a first inlet for a temperature control medium, a first outlet for the temperature control medium, a first distributor box fluidically connected to the first inlet, a first collector box fluidically connected to the first outlet, and a plurality of first connecting tubes fluidically connecting the first distributor box to the first collector box;
a second heat exchanger arranged distaly to the first heat exchanger including a second inlet for the temperature control medium, a second outlet for the temperature control medium, a second distributor box fluidically connected to the second inlet, a second collector box fluidically connected to the second outlet, and a plurality of second connecting tubes fluidically connecting the second distributor box to the second collector box;
a multi-channel tube including a supply connection and a discharge connection, the multi-channel tube connected to the first inlet, the second inlet, the first outlet, and the second outlet;
a supply channel disposed within the multi-channel tube connecting the supply connection to the first inlet and the second inlet in a parallel manner; and
a discharge channel disposed within the multi-channel tube connecting the discharge connection to the first outlet and the second outlet in a parallel manner.

20. The battery temperature control system according to claim 19, wherein one of:
the supply connection adjoins radially onto the multi-channel tube, penetrates the discharge channel internally in the multi-channel tube and opens out in the supply channel, wherein the temperature control medium is flowable around the supply connection in the discharge channel, and the discharge connection adjoins radially onto the multi-channel tube and opens directly in the discharge channel internally in the multi-channel tube; and
the discharge connection adjoins radially onto the multi-channel tube, penetrates the supply channel internally in the multi-channel tube and opens out in the discharge channel, wherein the temperature control medium is flowable around the discharge connection in the supply channel, and the supply connection adjoins radially onto the multi-channel tube and opens out directly in the supply channel internally in the multi-channel tube.
